(19) United States
(12) Patent Application Publication
(10) Pub. No.: US 2025/0299356 A1
(43) Pub. Date: Sep. 25, 2025

(54) SELF-LOCALIZATION ESTIMATION APPARATUS

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventor: Yoshiki HAYAKAWA, Tokyo (JP)

(21) Appl. No.: 19/083,030

(22) Filed: Mar. 18, 2025

(30) Foreign Application Priority Data
Mar. 21, 2024 (JP) 2024-045103

(51) Int. Cl. G06T 7/70; G06V 20/56

(52) U.S. Cl. CPC G06T 7/70; G06V 20/56

(57) ABSTRACT

In a self-localization estimation apparatus for a mobile object equipped with sensors, a self-position estimating unit performs self-position estimation tasks corresponding to the respective sensors with respective estimation accuracies. Each of the estimation accuracies depends on a measurement characteristic of the corresponding one of the sensors. An output self-position determiner determines, based on analysis of estimation results and the estimation accuracies of the respective self-position estimation tasks, a self-position of the mobile object estimated by a selected one of the self-position estimation tasks as an output self-localization position of the mobile object.

### CROSS REFERENCE TO RELATED APPLICATION

This application is based on and claims the benefit of priority from Japanese Patent Application No. 2024-045103 filed on Mar. 21, 2024, the disclosure of which is incorporated in its entirety herein by reference.

### TECHNICAL FIELD

The present disclosure relates to self-localization estimation apparatuses.

### BACKGROUND

Typical known technologies for self-localization of a mobile object, such as a vehicle, use measurement results from cameras and/or millimeter-wave radars installed in the mobile object.

For example, Japanese Patent Application Publication No. 2019-139400, which will be referred to as a first patent publication, discloses odometry estimation that uses measurement data from internal sensors, such as steering-angle sensors and/or wheel speed sensors, installed in a vehicle to estimate positions of the vehicle over time. In particular, this first patent publication corrects the estimated positions of the vehicle in accordance with measurement results from external sensors, such as a front camera and/or a front millimeter radar.

Japanese Patent Application Publication No. 2022-014729, which will be referred to as a second patent publication, discloses a method of fusing measurement results from a front camera and measurement results from a front millimeter-wave radar to accordingly estimate positions of the vehicle over time.

The accuracy of positions of a mobile object estimated by such a self-localization method of using sensors for monitoring the surrounding environments around the mobile object, such as cameras and/or millimeter-wave radars, may change depending on change in the surrounding environments. The change in the surrounding environments may include, for example, change in time zones, such as change between nighttime zone and daytime zone and change in weather conditions around the mobile object.

The first patent publication determines the correction accuracy of the front camera and/or the front millimeter-wave radar depending on the change in the surrounding environments, such as change in time zones and/or weather conditions around the mobile object. Then, the first patent publication determines the accuracy of the odometry estimation when determining that the correction accuracy of the front camera and/or the front millimeter-wave radar is low. Next, the first patent publication reduces the level of collision-avoidance assistance when determining that the accuracy of the odometry estimation is low.

The second patent publication acquires current condition information including ambient temperatures and/or the current time, and determines, based on the acquired current condition information, whether the current surrounding environments are poor environments, such as a misty atmosphere condition, a condition in which the mobile object is exposed to the afternoon sun, or a heavy-rain condition.

### SUMMARY

Unfortunately, the first patent publication merely determines the accuracy of the odometry estimation and/or reduces the level of collision-avoidance assistance when determining that the accuracy of the odometry estimation is low, and therefore the first patent publication may not disclose how to reduce a deterioration in accuracy of positions of a mobile object estimated by the odometry estimation due to change in the surrounding environments.

Additionally, the second patent publication merely determines, based on the current condition information, whether the current surrounding environments are poor environments about sensors for monitoring the surrounding environments around the mobile object, and therefore may not reduce a deterioration in accuracy of positions of a mobile object estimated based on the surrounding environments around the mobile object monitored by the sensors.

Accordingly, we have awaited the development of technologies of maintaining, at a higher level, the accuracy of an output position of a mobile object estimated based on the surrounding environments around the mobile object monitored by the sensors.

A first exemplary aspect of the present disclosure provides a self-localization estimation apparatus from the above viewpoints.

Specifically, the self-localization estimation apparatus is to be applied to a mobile object equipped with a plurality of sensors. Each of the sensors is configured to measure, as a measurement result, surrounding environments around the mobile object. The self-localization estimation apparatus includes a self-position estimating unit configured to perform a plurality of self-position estimation tasks corresponding to the respective sensors with respective estimation accuracies. Each of the estimation accuracies depends on a measurement characteristic of the corresponding one of the sensors.

The self-localization estimation apparatus additionally includes an output self-position determiner configured to determine, based on analysis of estimation results and the estimation accuracies of the respective self-position estimation tasks, a self-position of the mobile object estimated by a selected one of the self-position estimation tasks as an output self-localization position of the mobile object.

Additionally, a second exemplary aspect of the present disclosure provides a program product from the above viewpoints.

Specifically, the program product is to be used for self-localization of a mobile object equipped with a plurality of sensors. Each of the sensors is configured to measure, as a measurement result, surrounding environments around the mobile object. The program product includes a non-transitory storage medium that stores program instructions, and a processor for executing the program instructions stored in the non-transitory storage medium. The program instructions cause the processor to

(I) Perform a plurality of self-position estimation tasks corresponding to the respective sensors with respective estimation accuracies, each of the estimation accuracies depending on a measurement characteristic of the corresponding one of the sensors

(II) Determine, based on analysis of estimation results and the estimation accuracies of the respective self-position estimation tasks, an output self-localization position of the mobile object estimated by one of the self-position estimation tasks

Each of the self-localization estimation apparatus and the processor based on the program instructions is configured to perform the self-position estimation tasks corresponding to the respective sensors with respective estimation accuracies, each of the estimation accuracies depending on a measurement characteristic of the corresponding one of the sensors. Then, each of the self-localization estimation apparatus and the processor is configured to determine, based on analysis of estimation results and the estimation accuracies of the respective self-position estimation tasks, an output self-localization position of the mobile object estimated by one of the self-position estimation tasks.

Each of the self-localization estimation apparatus and the program product determines the output self-localization position of the mobile object based on analysis of the estimation accuracies of the respective self-position estimation tasks, making it possible to maintain, at a higher level, the accuracy of the output self-localization position of the mobile object estimated based on the surrounding environments around the mobile object measured by the sensors. In other words, each of the self-localization estimation apparatus and the program product makes it possible to suppress a deterioration in the accuracy of the output self-localization position of the mobile object estimated based on the surrounding environments around the mobile object measured by the sensors.

### BRIEF DESCRIPTION OF THE DRAWINGS

Other aspects of the present disclosure will become apparent from the following description of embodiments with reference to the accompanying drawings in which:

FIG. 1 is a block diagram illustrating a schematic configuration of a self-localization estimation apparatus according to the first embodiment of the present disclosure;

FIG. 2A is a diagram schematically illustrating map information according to the first embodiment;

FIG. 2B is a flowchart schematically illustrating a self-localization position determining routine according to the first embodiment;

FIG. 3 is a flowchart illustrating in detail a determination subroutine in step S125 of the flowchart illustrated in FIG. 2 according to the first embodiment;

FIG. 4 is a flowchart illustrating in detail a determination subroutine in step S125 of the flowchart illustrated in FIG. 2 according to the second embodiment of the present disclosure;

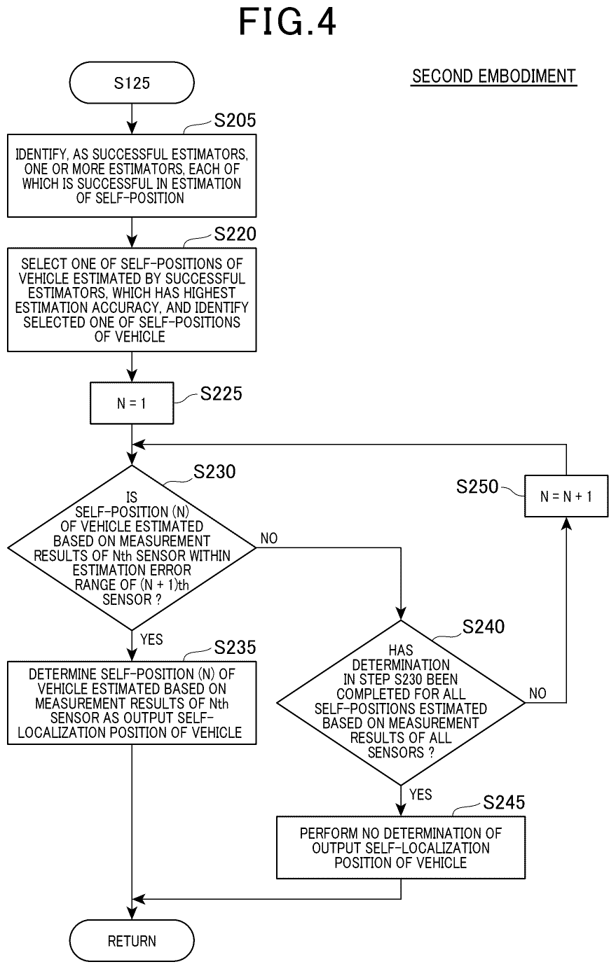

FIG. 5 is a block diagram illustrating a schematic configuration of a self-localization estimation apparatus according to the third embodiment of the present disclosure;

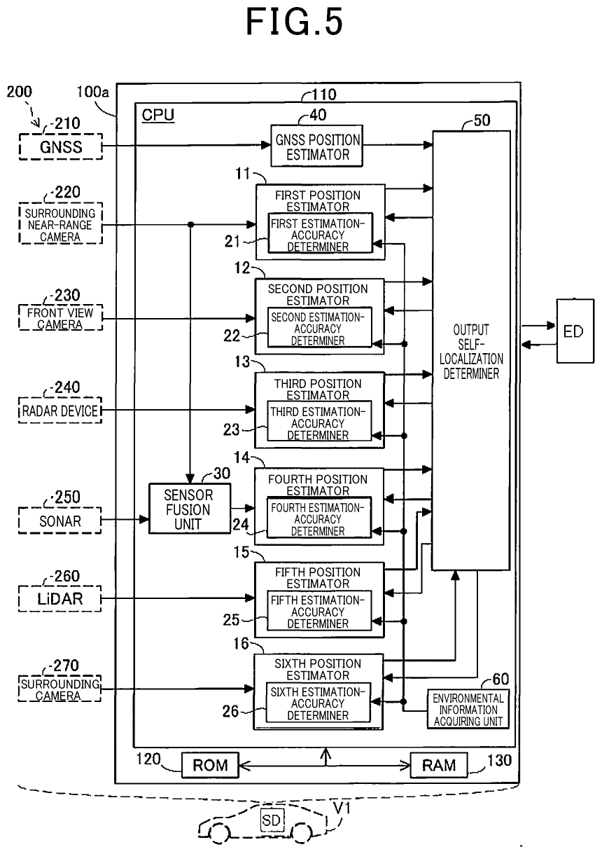

FIG. 6 is a flowchart schematically illustrating a self-localization position determining routine according to the third embodiment; and

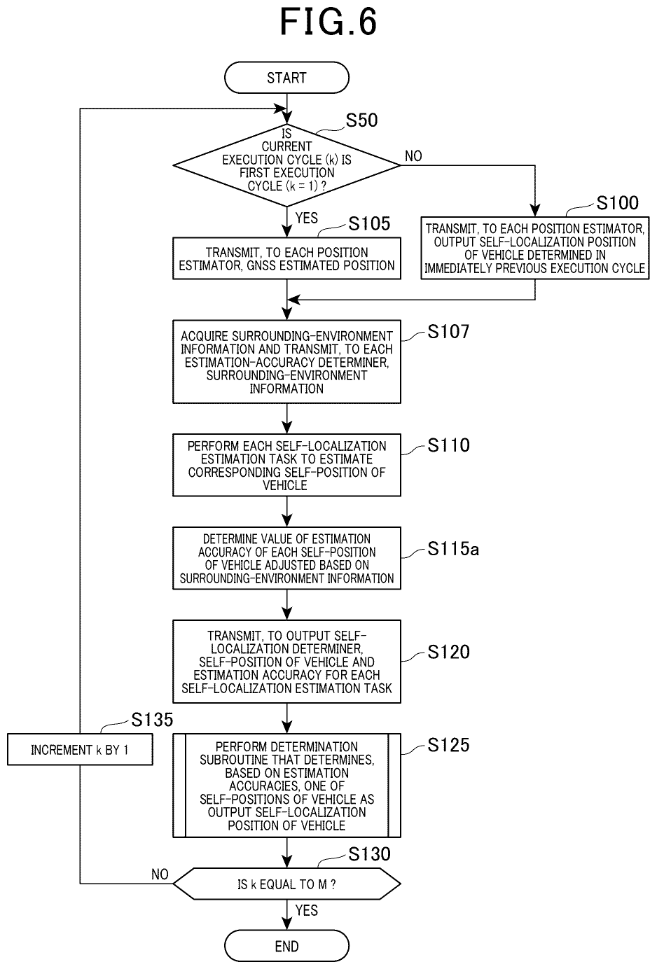

FIG. 7 is a diagram illustrating an example of an estimation accuracy table according to the third embodiment.

### DETAILED DESCRIPTION OF EMBODIMENT

### First Embodiment

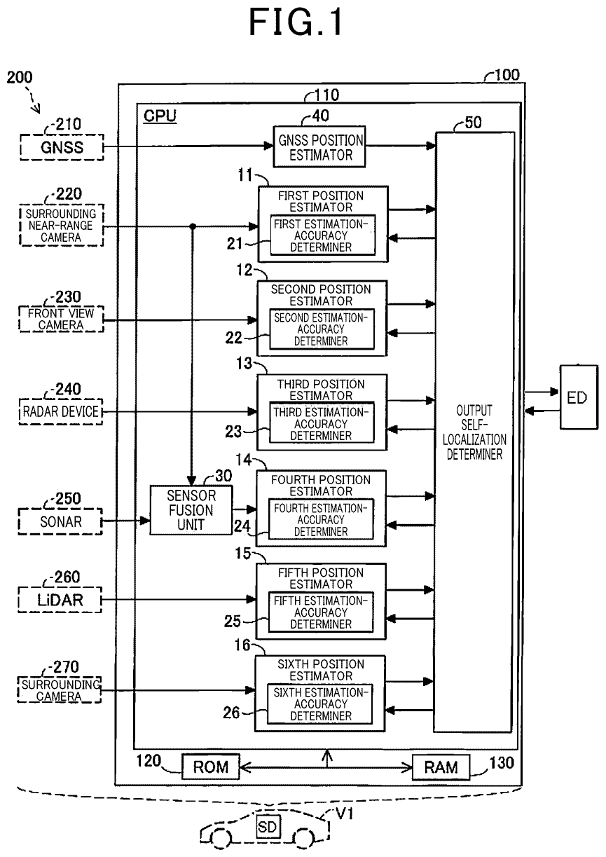

A self-localization estimation apparatus 100 illustrated in FIG. 1 is installed in a vehicle V1, and used to perform self-localization of the vehicle V1. The vehicle V1 is equipped with a group of sensors 200, which will be referred to as a sensor group 200 mounted thereto.

The sensor group 200 includes, for example, global navigation satellite system (GNSS) devices 210, a surrounding near-range camera 220, a front view camera 230, a radar device 240, a sonar 250, a light detection and ranging sensor (LIDAR) 260, and a surrounding camera 270. Each of the surrounding near-range camera 220, front view camera 230, radar device 240, sonar 250, LiDAR 260, and surrounding camera 270 serves as a sensor for monitoring surrounding environments around the vehicle V1.

The GNSS devices 210 constitute a GNSS. The GNSS devices 210 according to the first embodiment constitute a global positioning system (GPS) included in the GNSS, and includes at least one GPS receiver for receiving GPS signals, which are sent from GPS satellites. The GNSS devices 210 can constitute another global navigation satellite system, such as Quasi-Zenith Satellite System (QZSS), Global Navigation Satellite System (GLONASS), or Galileo.

The surrounding near-range camera 220 is configured to capture images of a near-range region located to surround the vehicle V1 using predetermined two-dimensional horizontal and vertical angular fields. The near-range region to be captured by the surrounding near-range camera 220 is previously defined to a predetermined area of a road surface within a radius of 5 meters from the vehicle V1. The surrounding near-range camera 220 can be mounted to, for example, the front grille or a side mirror of the vehicle V1.

The front view camera 230 is configured to capture images of a front view region of the vehicle V1 using predetermined two-dimensional horizontal and vertical angular fields. The front view camera 230 can be mounted to, for example, the upper end of the inner side of the front windshield, the front grille, or the roof tip of the vehicle V1.

The radar device 240 is configured to emit probe waves having a predetermined wavelength, such as millimeter waves or quasi-millimeter waves, and receive reflections from at least one object, i.e., at least one obstacle, based on the emitted probe waves. Then, the radar device 240 is configured to analyze the received reflections to accordingly calculate a relative distance and/or a relative speed of the at least one obstacle relative to the vehicle V1. The radar device 240 can be mounted to, for example, the front grille or the front bumper of the vehicle V1.

The sonar 250 is configured to emit sound waves as probe waves, and receive reflections from at least one object, i.e., at least one obstacle, based on the emitted sound waves. Then, the sonar 250 is configured to analyze the received reflections to accordingly calculate a relative distance and/or a relative speed of the at least one obstacle relative to the vehicle V1. The sonar 250 can be mounted to, for example, the front grille or the front bumper of the vehicle V1.

The LiDAR 260 is configured to emit laser pulses as probe waves, and receive reflections based on the emitted laser pulses. Then, the LIDAR 260 is configured to analyze the received reflections to accordingly a relative distance and/or a relative speed of at least one obstacle relative to the vehicle V1. The LiDAR 260 can be mounted to, for example, the front grille or the front bumper of the vehicle V1.

Like the surrounding near-range camera 200, the surrounding camera 270 is configured to capture images of a region located to surround the vehicle V1 using predetermined two-dimensional horizontal and vertical angular fields. In particular, the surrounding camera 270 is configured to capture, with higher resolution, a relatively wide-range region located to surround the vehicle V1.

For example, the surrounding camera 270 is capable of capturing an image of two objects from several tens to several hundreds of meters away from the vehicle V1 while the two objects can be individually identified on the image. Like the surrounding near-range camera 220, the surrounding camera 270 can be mounted to, for example, the front grille or each side mirror of the vehicle V1.

Each of the cameras 220, 230, and 270 is comprised of an imaging sensor and a lens system, and is configured to capture an image of the corresponding two-dimensional angular field based on incoming light being focused through the lens system on a two-dimensional pixel region of the imaging sensor thereof; the two-dimensional pixel region is comprised of light-sensitive elements serving as pixels arranged in a two-dimensional array in both vertical and horizontal directions corresponding to, for example, the respective height direction and width direction of the vehicle V1. This results in each of the two-dimensionally arranged light-sensitive elements (pixels) receiving a corresponding light component. Each pixel of the image captured by each camera 220, 230, and 270 therefore has the corresponding intensity or luminance level of the received light component as a luminance value of the corresponding pixel.

The self-localization estimation apparatus 100 is, for example, configured as an electronic control unit (ECU) comprised of a CPU 110, a ROM 120, and a RAM 130 according to the first embodiment. The self-localization estimation apparatus 100 is configured to communicate data with each of the above devices 210 to 270 constituting the sensor group 200 through one or more networks, such as a Controller Area Network (CAN) installed in the vehicle V1.

As the ROM 120, an electrically erasable programmable read-only memory (EEPROM), which enables individual data stored therein to be erased and/or reprogrammed, can be used.

The CPU 110 is configured to execute programs, i.e., program instructions stored in the ROM 120 and/or the RAM 130 to accordingly serve as a GNSS position estimator 40, a first position estimator 11, a second position estimator 12, a third position estimator 13, a fourth position estimator 14, a fifth position estimator 15, a sixth position estimator 16, a sensor fusion unit 30, and an output self-localization determiner 50.

The GNSS position estimator 40 is configured to perform a GNSS self-localization estimation task of receiving signals outputted from the GNSS devices 210, and estimating, based on the received signals, the current position of the vehicle V1, i.e., the current position of the GNSS devices 210. As described above, the GNSS devices 210 according to the first embodiment, which constitute the GPS, receives the GPS signals sent from the GPS satellites, and the GNSS position estimator 40 is configured to estimate, based on the GPS signals received by and outputted from the GNSS devices 210, the current position of the vehicle V1, i.e., the current longitude and the current latitude of the vehicle V1. The current position estimated by the GNSS position estimator 40 may contain an error of approximately several tens of centimeters to several meters. The position of the vehicle V1 estimated by the GNSS position estimator 40 is outputted therefrom to the output self-localization determiner 50 as a GNSS estimated position of the vehicle V1. In particular, the GNSS position estimator 40 is configured to iteratively perform the GNSS self-localization estimation task every predetermined period. For example, the GNSS position estimator 40 can be configured to perform the GNSS self-localization estimation task once every 100 milliseconds.

The first position estimator 11 is configured to perform a first self-localization estimation task of receiving an image captured by the surrounding near-range camera 220, and estimating, based on the received image, a self-position of the vehicle V1.

In particular, the ROM 120, the RAM 130, or a storage device SD installed in the vehicle V1 stores beforehand map information I.

The map information I includes a relationship between (i) various patterns, i.e., various designs, appearing on road surfaces on which the vehicle V1 can travel and (ii) positional information items in a predetermined reference coordinate system, such as a world coordinate system, that is defined for the vehicle V1 such that each of the various patterns correlates with the corresponding one of the positional information items in the reference coordinate system. Each of the positional information items enables a corresponding position in the reference coordinate system to be identified.

The first self-localization estimation task recognizes a road-surface pattern included in the captured image based on the luminance levels of the respective pixels of the captured image. Then, the first self-localization estimation task performs a first matching task of referring to the map information I using the recognized road-surface pattern to accordingly identify a road-surface pattern included in the map information I corresponding to the recognized road-surface pattern.

Then, the first self-localization estimation task extracts, from the map information I, one or more of the positional information items matching the identified road-surface pattern.

Next, the first self-localization estimation task estimates, based on (i) the extracted one or more positional information items and, for example, (ii) a previously determined relative positional relationship between the vehicle V1 and the near-range region of the surrounding near-range camera 220, a position of any point, such as the center of gravity, of the vehicle V1 in the reference coordinate system.

The patterns appearing on each road surface include a pattern, i.e., a design, created by (i) one or more colored lines, such as white lines, formed on the corresponding road surface, (ii) one or more road signs formed on the corresponding road surface, (iii) one or more manhole covers formed on the corresponding road-surface section, (iv) one or more side ditches, and/or one or (v) more road shoulders.

The map information I additionally includes a relationship between (i) various points, each of which represents a corresponding part of a corresponding one of existing natural/human-made features, such as buildings or guardrails, on or around the road surfaces and (ii) the positional information items in the reference coordinate system such that each of the feature points correlates with the corresponding one of the positional information items in the reference coordinate system. The various points of each existing natural/human-made feature constitute point cloud data of the corresponding existing natural/human-made feature.

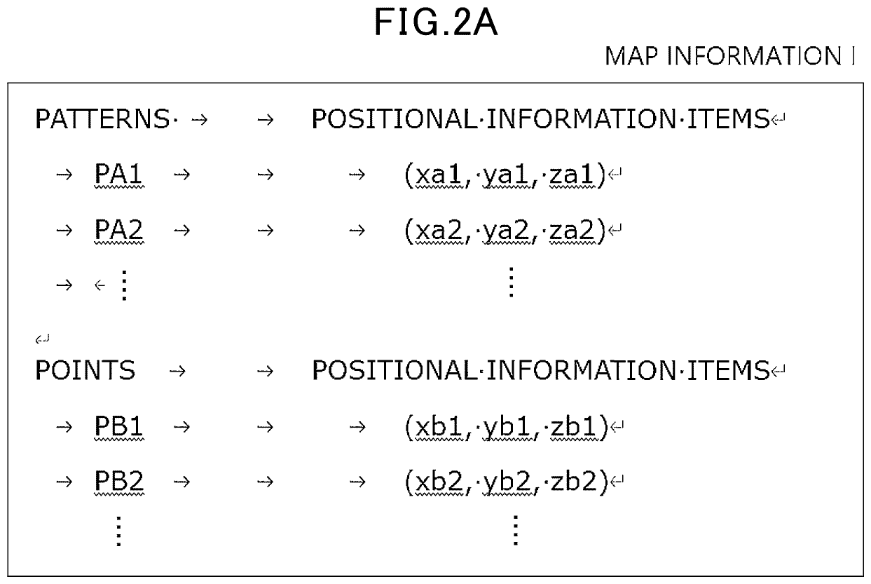

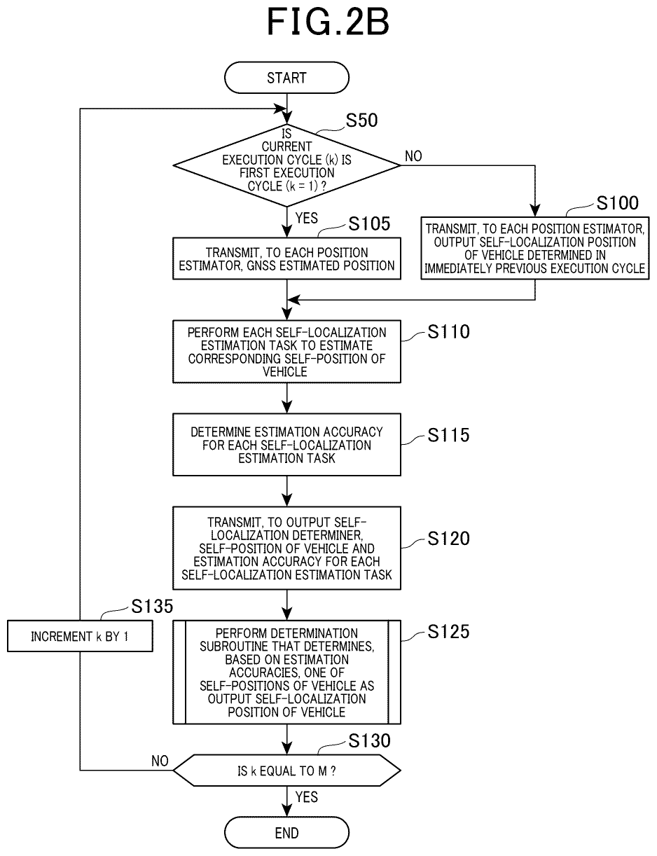

For example, the map information I illustrated in FIG. 2A shows the relationship between (i) various patterns PA1, PA2, . . . and (ii) respective positional information items, i.e., three-dimensional coordinates, (xa1, ya1, za1), (xa2, ya2, za2), . . . . Similarly, the map information I illustrated in FIG. 2A shows the relationship between (i) various points PB1, PB2, . . . and (ii) respective positional information items, 25 i.e., three-dimensional coordinates, (xb1, yb1, zb1), (xb2, yb2, zb2), . . . .

The first position estimator 11 includes a first estimation accuracy determiner 21. Similarly, the second to sixth position estimators 12 to 16 include respective second to sixth estimation accuracy determiners 22 to 26. The first estimation accuracy determiner 21 is configured to determine the estimation accuracy of the self-position of the vehicle V1 estimated by the first self-localization estimation task carried out by the first position estimator 11. How the first to sixth estimation accuracy determiner 21 to 26 respectively perform the identification will be described later.

The second position estimator 12 is configured to perform a second self-localization estimation task of receiving an image captured by the front view camera 230, and estimating, based on the received image, the current position of the vehicle V1.

In particular, the second self-localization estimation task extracts, from the image received from the front view camera 230, feature points, i.e., characteristic points, based on change in the luminance levels of the respective pixels of the image. The feature points extracted by the second self-localization estimation task from the image received from the front view camera 230 can include, for example, (i) feature points representing edges in the image, and (ii) feature points, each of which corresponds to a specific pixel in the image whose luminance level is higher than those of any other pixels surrounding the specific pixel.

The second self-localization estimation task performs a second matching task of referring to the map information I using the extracted feature points, i.e., a pattern of the extracted feature points, to accordingly identify one or more points of the point cloud data included in the map information I corresponding to the pattern of the feature points extracted from the image. Then, the second self-localization estimation task extracts, from the map information I, one or more of the positional information items in the reference coordinate system matching the identified one or more points of the point cloud data.

Next, the second self-localization estimation task estimates, based on (i) the extracted one or more positional information items and, for example, (ii) a previously determined relative positional relationship between the vehicle V1 and the front view region to be captured by the front view camera 230, a self-position of the vehicle V1 in the reference coordinate system.

The second estimation accuracy determiner 22 included in the second position estimator 12 is configured to determine the estimation accuracy of the self-position of the vehicle V1 estimated by the second self-localization estimation task carried out by the second position estimator 12.

The third position estimator 13 is configured to perform a third self-localization estimation task of receiving, as measurement results, radar reflection points outputted from the radar device 240, and estimating, based on the received measurement results, the current position of the vehicle V1; each of the radar reflection points of one or more objects reflects a corresponding one of the probe waves emitted from the radar device 240.

Specifically, the third self-localization estimation task performs a third matching task of referring to the map information I using the radar reflection points to accordingly identify one or more points of the point cloud data included in the map information I corresponding to the radar reflection points. Then, the third self-localization estimation task extracts, from the map information I, one or more of the positional information items in the reference coordinate system matching the identified one or more points of the point cloud data.

Next, the third self-localization estimation task estimates, based on (i) the extracted one or more positional information items and, for example, (ii) a previously determined relative positional relationship, such as a relative distance, between the vehicle V1 and each radar reflection point, a self-position of the vehicle V1 in the reference coordinate system.

The third estimation accuracy determiner 23 included in the third position estimator 13 is configured to determine the estimation accuracy of the self-position of the vehicle V1 estimated by the third self-localization estimation task carried out by the third position estimator 13.

The sensor fusion unit 30 is configured to receiving an image captured by the surrounding near-range camera 220 and reflection points, which will be referred to as sonar reflection points, outputted from the sonar 250 as measurement results. Then, the sensor fusion unit 30 is configured to extract, from the image captured by the surrounding near-range camera 220, image-based feature points based on change in the luminance levels of the respective pixels of the image; each of the sonar reflection points of one or more objects reflects a corresponding one of the sound waves emitted from the sonar 250.

Then, the sensor fusion unit 30 is configured to fuse the image-based feature points and the sonar reflection points with one another to accordingly identify, i.e., estimate, fusion feature points of one or more objects that are likely to exist around the vehicle V1 with high accuracy.

The fourth position estimator 14 is configured to perform a fourth self-localization estimation task of receiving the fusion feature points outputted from the sensor fusion unit 30, and estimating, based on the received fused feature points.

Specifically, the fourth self-localization estimation task performs a fourth matching task of referring to the map information I using the recognized fusion feature points to accordingly identify one or more points of the point cloud data included in the map information I corresponding to the one or more recognized fusion feature points. Then, the fourth self-localization estimation task extracts, from the map information I, one or more of the positional information items in the reference coordinate system matching the identified one or more points of the point cloud data.

Next, the fourth self-localization estimation task estimates, based on (i) the extracted one or more positional information items and, for example, (ii) a previously determined relative positional relationship, such as a relative distance, between the vehicle V1 and each fusion feature points, a self-position of the vehicle V1 in the reference coordinate system.

The fourth estimation accuracy determiner 24 included in the fourth position estimator 14 is configured to determine the estimation accuracy of the self-position of the vehicle V1 estimated by the fourth self-localization estimation task carried out by the fourth position estimator 14.

The fifth position estimator 15 is configured to perform a fifth self-localization estimation task of receiving, as measurement results, LiDAR reflection points outputted from the LiDAR 260, and estimating, based on the received measurement results, the current position of the vehicle V1; each of the LiDAR reflection points of one or more objects reflects a corresponding one of the laser pulses emitted from the LiDAR 260.

Specifically, the fifth self-localization estimation task performs a fifth matching task of referring to the map information I using the LiDAR reflection points to accordingly identify one or more points of the point cloud data included in the map information I corresponding to the LiDAR reflection points. Then, the fifth self-localization estimation task extracts, from the map information I, one or more of the positional information items in the reference coordinate system matching the identified one or more points of the point cloud data.

Next, the fifth self-localization estimation task estimates, based on (i) the extracted one or more positional information items and, for example, (ii) a previously determined relative positional relationship, such as a relative distance, between the vehicle V1 and each LiDAR reflection point, a self-position of the vehicle V1 in the reference coordinate system.

The fifth estimation accuracy determiner 25 included in the fifth position estimator 15 is configured to determine the estimation accuracy of the self-position of the vehicle V1 estimated by the fifth self-localization estimation task carried out by the fifth position estimator 15.

The sixth position estimator 16 is configured to perform a sixth self-localization estimation task of receiving an image captured by the surrounding camera 270, and estimating, based on the received image, the current position of the vehicle V1.

In particular, like the second self-estimation estimation task, the sixth self-localization estimation task extracts, from the image received from the surrounding camera 270, feature points, i.e., characteristic points, based on change in the luminance levels of the respective pixels of the image.

The sixth self-localization estimation task performs a sixth matching task of referring to the map information I using the extracted feature points, i.e., a pattern of the extracted feature points, to accordingly identify one or more points of the point cloud data included in the map information I corresponding to the pattern of the feature points extracted from the image. Then, the sixth self-localization estimation task extracts, from the map information I, one or more of the positional information items in the reference coordinate system matching the identified one or more points of the point cloud data.

Next, the sixth self-localization estimation task estimates, based on (i) the extracted one or more positional information items and, for example, (ii) a previously determined relative positional relationship between the vehicle V1 and the relatively wide-range region to be captured by the surrounding camera 270, the extracted one or more positional information items, a self-position of the vehicle V1 in the reference coordinate system.

The sixth estimation accuracy determiner 27 included in the sixth position estimator 16 is configured to determine the estimation accuracy of the self-position of the vehicle V1 estimated by the sixth self-localization estimation task carried out by the sixth position estimator 16.

For example, the ROM 120 stores an estimation accuracy previously determined for the respective first to sixth self-localization estimation tasks as fixed levels. Each of the estimation accuracies of the corresponding one of the first to sixth self-localization estimation tasks was previously determined as a deviation amount, i.e., a deviation distance, of the corresponding estimated self-position of the vehicle V1 from an actual position of the vehicle V1 using, for example, experiments or simulations.

For example, each of the first to sixth self-localization estimation tasks using the corresponding one of the sensors 220 to 270 was carried plural cycles, and, for each cycle, each of the self-positions of the vehicle V1 estimated by the corresponding one of the first to sixth self-localization estimation tasks was compared with the corresponding one of the actual positions of the vehicle V1. This resulted in, for each cycle, each of the deviation amounts, i.e., deviation distances, being determined for the corresponding one of the first to sixth self-localization estimation tasks.

For each of the first to sixth self-localization estimation tasks, a statistical value, such as an average value or a maximum value, of the deviation amounts determined for the respective cycles was calculated as the estimation accuracy of the corresponding one of the first to sixth self-localization estimation tasks.

Each of the estimation accuracies of the corresponding one of the first to sixth self-localization estimation tasks for example depends on measurement characteristics of the corresponding one of the sensors 220 to 270.

For example, the estimation accuracy of the first self-localization estimation task using the surrounding near-range camera 220 is 10 centimeters. The estimation accuracy of the second self-localization estimation task using the front view camera 230 is 1 meter. The estimation accuracy of the third self-localization estimation task using the radar device 240 is 1 meter. The estimation accuracy of the fourth self-localization estimation task using the sonar 250 is 30 centimeters. The estimation accuracy of the fifth self-localization estimation task using the LIDAR 260 is 20 centimeters. The estimation accuracy of the sixth self-localization estimation task using the surrounding camera 270 is 50 centimeters.

Each of the first to sixth estimation accuracy determiners 21 to 26 is configured to refer to the estimation accuracy of the corresponding one of the first to sixth self-localization estimation tasks stored in the ROM 120 to accordingly determine the estimation accuracy of each of the first to sixth self-localization estimation tasks.

The output self-localization determiner 50 is configured to be able to communicate various data with the GNSS devices 210 and the first to sixth position estimators 11 to 16.

The output self-localization determiner 50 is configured to compare the estimation accuracies of the respective first to sixth self-localization estimation tasks with one another to accordingly select one of the self-positions of the vehicle V1 estimated by the corresponding one of the first to sixth self-localization estimation tasks. Then, the output self-localization determiner 50 is configured to determine the selected one of the self-positions of the vehicle V1 as an output self-localization position of the vehicle V1.

The output self-localization determiner 50 of the self-localization estimation apparatus 100 is configured to output the determined final self-localization position of the vehicle V1 to one or more external devices ED, such as one or more other ECUs installed in the vehicle V1; the one or more other ECUs can include, for example, ECUs for safety driving assistance of the vehicle V1 and/or ECUs for controlling autonomous driving of the vehicle V1 if the vehicle V1 is configured as an autonomous driving vehicle. The ECUs for safety driving assistance of the vehicle V1 can include, for example, an ECU for determining whether the vehicle V1 will collide with one or more objects, an ECU for performing automatic braking of the vehicle V1 to avoid collision of the vehicle V1 with one or more objects, and an ECU for performing automatic steering of the vehicle V1. Each of the other ECUs can be configured to perform a corresponding operation, such as the collision determination operation or the autonomous driving control operation, in accordance with the output self-localization position of the vehicle V1 transmitted from the output self-localization determiner 50 of the self-localization estimation apparatus 100.

That is, as described above, the output self-localization determiner 50 is configured to determine whether to output one of the self-positions of the vehicle V1 estimated by the corresponding one of the first to sixth self-localization estimation tasks as the output self-localization position of the vehicle V1. How the output self-localization determiner 50 determines one of the self-positions of the vehicle V1 estimated by the corresponding one of the first to sixth self-localization estimation tasks as the output self-localization position of the vehicle V1 will be described later.

In particular, the CPU 110 of the self-localization estimation apparatus 100 is configured to execute a self-localization position determining routine, which is illustrated in FIG. 2B, in accordance with instructions of a self-localization position determining program stored in, for example, the ROM 120.

Specifically, in response to the self-localization estimation apparatus 100 being powered on, the CPU 110 of the self-localization estimation apparatus 100 is programmed to iterate the self-localization position determining routine illustrated in FIG. 2B. One execution of the self-localization position determining routine by the CPU 110 will be referred to as an execution cycle. That is, the CPU 110 of the self-localization estimation apparatus 100 is programmed to iterate the self-localization position determining routine until the number of execution cycles of the self-localization position determining routine reaches an Mth execution cycle (M is an integer more than or equal to 2).

When starting the self-localization position determining routine, the CPU 110 serves as the output self-localization determiner 50 to set a cycle number parameter k to 1, and determine whether the current execution cycle of the self-localization position determining routine started after the power-on of the output self-localization determiner 50 is the first execution cycle, in other words, whether the cycle number parameter k is equal to 1, in step S50. In response to determination that the current execution cycle of the self-localization position determining routine started after the power-on of the output self-localization determiner 50 is the first execution cycle, i.e., the cycle number parameter k is equal to 1, (YES in step S50), the current execution cycle of the self-localization position determining routine proceeds to step S105.

In step S105, the CPU 110 serves as, for example, the output self-localization determiner 50 to receive information indictive of the GNSS estimated position of the vehicle V1 outputted from the GNSS position estimator 40, and transmit, to each of the first to sixth position estimators 11 to 16, the information indictive of the GNSS estimated position of the vehicle V1 received from the GNSS position estimator 40.

Following the operation in step S105, the CPU 110 serves as, for example, each of the first to sixth position estimators 11 to 16 to perform the corresponding one of the first to sixth self-localization estimation tasks to accordingly estimate the corresponding one of the self-positions of the vehicle V1 in the reference coordinate system in step S110.

In particular, each of the first to sixth matching tasks of the corresponding one of the first to sixth self-localization estimation tasks refers to, based on the GNSS estimated position of the vehicle V1, a limited range of the map information I; the positional information items included in the limited range of the map information I enclose the GNSS estimated position of the vehicle V1.

This configuration prevents, even if there is another road-surface pattern included in the map information I, which is located to be far away from the GNSS estimated position of the vehicle V1 and is similar to the road-surface pattern recognized in a captured image, wrong estimation of the position of the vehicle V1 based on the other road-surface pattern. This therefore prevents a reduction in the estimation accuracy of the self-position of the vehicle V1.

Similarly, this configuration prevents, even if there are other points of the point cloud data included in the map information I, which are located to be far away from the GNSS estimated position of the vehicle V1 and are similar to the feature points extracted from a captured image, wrong estimation of the self-position of the vehicle V1 based on the other feature points. This therefore prevents a reduction in the estimation accuracy of the position of the vehicle V1.

Additionally, this configuration prevents, even if there are other points of the point cloud data included in the map information I, which are located to be far away from the GNSS estimated position of the vehicle V1 and are similar to the radar/sonar/LiDAR reflection points outputted from a corresponding sensor, wrong estimation of the position of the vehicle V1 based on the other points of the point cloud data. This therefore prevents a reduction in the estimation accuracy of the self-position of the vehicle V1.

Following the operation in step S110, the CPU 110 serves as, for example, each of the first to sixth estimation accuracy determiners 21 to 26 to determine the estimation accuracy of the corresponding one of the self-positions of the vehicle V1 estimated by the corresponding one of the first to sixth self-localization estimation tasks carried out by the corresponding one of the first to sixth position estimators 11 to 16 in step S115.

Specifically, the identification reads out, from the ROM 120, the estimation accuracies previously determined for the respective first to sixth self-localization estimation tasks to thereby determine the estimation accuracies of the respective first to sixth self-localization estimation tasks in step S115.

Following the operation in step S115, the CPU 110 serves as, for example, at least one of the first to sixth position estimators 11 to 16 to transmit, to the output self-localization determiner 50, (i) the corresponding at least one of the self-positions of the vehicle V1 estimated thereby and (ii) the estimation accuracy of the corresponding at least one of the first to sixth position estimators 11 to 16 in step S120.

For example, if it is determined that one of the self-positions of the vehicle V1 estimated by the corresponding one of the first to sixth position estimators 11 to 16 deviates from the GNSS estimated position of the vehicle V1, the corresponding one of the first to sixth position estimators 11 to 16 can be configured not to transmit, to the output self-localization determiner 50, the corresponding one of the self-positions of the vehicle V1 estimated thereby and (ii) the estimation accuracy of the corresponding one of the first to sixth position estimators 11 to 16.

Next, the CPU 110 serves as, for example, the output self-localization determiner 50 to perform a determination subroutine that determines, based on the at least one of the self-positions of the vehicle V1 and the estimation accuracy of the at least one of the first to sixth position estimators 11 to 16, an output self-localization position of the vehicle V1 in step S125.

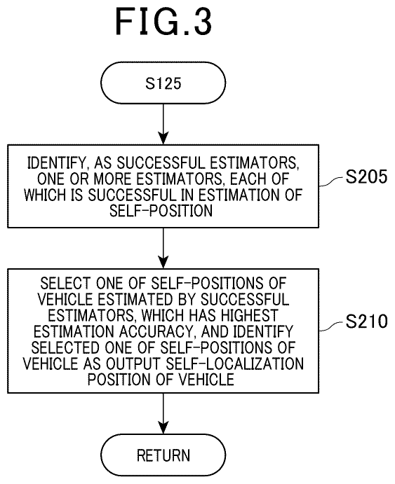

In particular, the determination subroutine in step S125 includes, for example, the following operations in steps S205 and S210 illustrated in FIG. 3.

Specifically, the CPU 110 serves as, for example, the output self-localization determiner 50 to identify, based on analysis of estimation results of the first to sixth self-position estimation tasks, one or more estimators in the first to sixth position estimators 11 to 16, each of which is successful in estimation of the corresponding self-position of the vehicle V1 in step S205 of the determination subroutine. The estimators in the first to sixth position estimators 11 to 16, each of which is successful in estimation of the corresponding self-position of the vehicle V1, will be referred to as successful estimators.

Next, the CPU 110 serves as, for example, the output self-localization determiner 50 to select one of the self-positions of the vehicle V1 estimated by the identified successful estimators, the estimation accuracy of the selected one of the self-positions of the vehicle V1 estimated by the identified successful estimators is the highest in all the identified successful estimators, thus determining the selected one of the self-positions of the vehicle V1 estimated by the identified successful estimators as the output self-localization position of the vehicle V1 in step S210.

Any position estimator 11 to 16, which is successful in estimation of the corresponding position of the vehicle V1, means that
(I) There are no malfunctions in the corresponding sensor 220 to 270
(II) Estimation of a self-position of the vehicle V1 is carried out under a situation where one or more predetermined measurement conditions for the corresponding position estimator 11 to 16 are satisfied, so that the self-position of the vehicle V1 estimated by the corresponding position estimator 11 to 16 is transmitted to the output self-localization determiner 50

Accordingly, if one of the first to sixth position estimators 11 to 16, which cannot transmit the estimated position due to a failure in the corresponding one of the sensors 220 to 270, the one of the first to sixth position estimators 11 to 16 is determined to be unsuccessful in estimation of the corresponding self-position of the vehicle V1.

Additionally, let us assume that, for example, the sixth self-localization estimation task cannot extract any feature point from an image captured by the surrounding camera 270, because the vehicle V1 is traveling in a traffic situation, such as traveling in a tunnel located in an expressway, so that a wall only appears in the image captured by the surrounding camera 270. In this assumption, because the sixth self-localization estimation task cannot extract, from the image, any pattern of feature points and therefore cannot identify one or more points of the point cloud data included in the map information I, the sixth self-localization estimator 16 cannot transmit a position of the vehicle V1 so that the sixth position estimator 16 is determined to be unsuccessful in estimation of the corresponding self-position of the vehicle V1.

For example, if all the first to sixth position estimators 11 to 16 are each successful in estimation of the corresponding self-position of the vehicle V1, the output self-localization determiner 50 determines, as the output self-localization position of the vehicle V1, the self-position of the vehicle V1 estimated by the first self-localization estimation task with the surrounding near-range camera 220, the estimation accuracy, i.e., 100 centimeters, of which is the highest in all the first to sixth position estimators 11 to 16 in step S210.

Let us assume that the first position estimator 11 is determined to be unsuccessful in estimation of the self-position of the vehicle V1 using the surrounding near-range camera 220 due to, for example, a failure of the surrounding near-range camera 220 or snowfall. In this assumption, the output self-localization determiner 50 determines, as the output self-localization position of the vehicle V1, the self-position of the vehicle V1 estimated by the fifth position of the vehicle V1 estimated by the fifth self-localization estimation task with the LiDAR 260, the estimation accuracy, i.e., 20 centimeters, of which is the highest in all the remaining second to sixth position estimators 12 to 16 in step S210. Then, the output self-localization determiner 50 outputs the determined final self-localization position of the vehicle V1 to the one or more external devices, such as one or more other ECUs installed in the vehicle V1 in step S210, i.e., S125.

After completion of the operation in step S125, the CPU 110 serves as, for example, the output self-localization determiner 50 to determine whether the number of execution cycles of the self-localization position determining routine reaches the Mth execution cycle, i.e., the cycle number parameter k is equal to M in step S130.

Upon determination that the number of execution cycles of the self-localization position determining routine does not reach the Mth execution cycle, i.e., the cycle number parameter k is not equal to M (NO in step S130), the CPU 110 serves as, for example, the output self-localization determiner 50 to increment the cycle number parameter k by 1 in step S135, and thereafter the CPU 110 returns to step S50 of the kth execution cycle of the self-localization position determining routine and starts to execute the kth execution cycle of the self-localization position determining routine from the operation in step S50.

Otherwise, upon determination that the number of execution cycles of the self-localization position determining routine reaches the Mth execution cycle, i.e., the cycle number parameter k is equal to M (YES in step S130), the CPU 110 terminates the Mth execution cycle of the self-localization position determining routine.

In the determination in step S50 of each of the second to the Mth execution cycles of the self-localization position determining routine, the CPU 110 serves as the output self-localization determiner 50 to determine that the current execution cycle of the self-localization position determining routine started after the power-on of the output self-localization determiner 50 is not the first execution cycle, i.e., the cycle number parameter k is not equal to 1, (NO in step S50). Then, the current execution cycle of the self-localization position determining routine proceeds to step S100.

In step S100, the CPU 110 serves as, for example, the output self-localization determiner 50 to transmit, to each of the first to sixth position estimators 11 to 16, the output self-localization position of the vehicle V1 determined in the immediately previous execution cycle of the self-localization position determining routine.

At that time, in step S110 following the operation in step S100, each of the first to sixth matching tasks of the corresponding one of the first to sixth self-localization estimation tasks refers to, based on the output self-localization position of the vehicle V1 determined in the immediately previous execution cycle of the self-localization position determining routine, a limited range of the map information I; the positional information items included in the limited range of the map information I enclose the output self-localization position of the vehicle V1 determined in the immediately previous execution cycle of the self-localization position determining routine. This therefore increases the probability of a pattern, one or more feature points, or radar/sonar/LiDAR reflection points measured by the corresponding sensor being matched with the limited range of the map information I, making it possible to improve the estimation accuracy of the self-localization position of the vehicle V1.

The self-localization estimation apparatus 100 of the first embodiment achieves the following advantageous benefits.

Specifically, the self-localization estimation apparatus 100 is configured to perform the first to sixth self-position estimation tasks corresponding to the respective sensors 22 to 27 with respective estimation accuracies, each of the estimation accuracies depending on a measurement characteristic of the corresponding one of the sensors 22 to 27.

Then, the self-localization estimation apparatus 100 is configured to determine, based on analysis of estimation results and the estimation accuracies of the respective first to sixth self-position estimation tasks, a self-position of the vehicle V1 estimated by a selected one of the first to sixth self-position estimation tasks as the output self-localization position of the vehicle V1.

That is, the self-localization estimation apparatus 100 determines the output self-localization position of the vehicle V1 based on analysis of the estimation accuracies of the respective first to sixth self-position estimation tasks, making it possible to maintain, at a higher level, the accuracy of the output self-localization position of the vehicle V1 estimated based on the surrounding environments around the vehicle V1 measured by the sensors 220 to 270. In other words, the self-localization estimation apparatus 100 makes it possible to suppress a deterioration in the accuracy of the output self-localization position of the vehicle V1 estimated based on the surrounding environments around the vehicle V1 measured by the sensors 220 to 270.

### Second Embodiment

The hardware configuration of a self-localization estimation apparatus 100 according to the second embodiment is identical to the hardware configuration of the self-localization estimation apparatus 100 according to the first embodiment. For this reason, reference characters used for the components of the self-localization estimation apparatus 100 of the first embodiment are assigned to the same components of the self-localization estimation apparatus 100 of the second embodiment, and therefore the detailed descriptions for the same components of the self-localization estimation apparatus 100 of the second embodiment are omitted.

The determination subroutine in step S125 of a self-localization position determining routine according to the second embodiment differs from the determination subroutine in step S125 of the self-localization position determining routine according to the first embodiment.

The determination subroutine in step S125 according to the second embodiment includes operations in steps S220, S225, S230, S235, S240, S245, and S250 in place of the operation in step S210.

After completion of the operation in step S205, the CPU 110 serves as, for example, the output self-localization determiner 50 to select one of the positions of the vehicle V1 estimated by the identified successful estimators, the estimation accuracy of the selected one of the positions of the vehicle V1 estimated by the identified successful estimators is the highest in all the identified successful estimators, thus determining the selected one of the positions of the vehicle V1 estimated by the identified successful estimators in step S220. The operation in step S220, which differs from the operation in step S210, is not to determine the selected one of the positions of the vehicle V1 estimated by the identified successful estimators as the output self-localization position of the vehicle V1.

Following the operation in step S220, the CPU 110 serves as, for example, the output self-localization determiner 50 to assign 1 to a variable N in step S225; the variable N represents the order of estimation accuracy among the sensors 220 to 270. That is, the Nth sensor selected from the sensors 220 to 270, which will be referred to as an Nth sensor, has the Nth order of estimation accuracy among the sensors 220 to 270. The self-position of the vehicle V1 estimated based on the measurement results of the Nth sensor will also be referred to as a self-position (N) of the vehicle V1.

Following the operation in step S225, the CPU 110 serves as, for example, the output self-localization determiner 50 to determine whether the self-position (N) of the vehicle V1 estimated based on the measurement results of the Nth sensor is within an estimation error range of the (N+1)th sensor in step S230.

The estimation error range of the (N+1)th sensor is defined as a circular range around the self-position estimated based on the measurement results of the (N+1)th sensor; the circular range has a radius. The radius of the estimation error range for each of the sensors 220 to 270 is previously set for the corresponding one of the sensors 220 15 to 270, and the radii for the respective sensors 220 to 270 are stored beforehand in the ROM 120, the RAM 130, or the storage device SD.

For example, 10 centimeters determined for the estimation accuracy of the first self-localization estimation task is set to be stored in the ROM 120, the RAM 130, or the storage device SD as the radius of the estimation error range for the surrounding near-range camera 220. 1 meter determined for the estimation accuracy of the second self-localization estimation task is set to be stored in the ROM 120, the RAM 130, or the storage device SD as the radius of the estimation error range for the front view camera 230. 1 meter determined for the estimation accuracy of the third self-localization estimation task is set to be stored in the ROM 120, the RAM 130, or the storage device SD as the radius of the estimation error range for the radar device 240. 30 centimeters determined for the estimation accuracy of the fourth self-localization estimation task is set to be stored in the ROM 120, the RAM 130, or the storage device SD as the radius of the estimation error range for the sonar 250. 20 centimeters determined for the estimation accuracy of the fifth self-localization estimation task is set to be stored in the ROM 120, the RAM 130, or the storage device SD as the radius of the estimation error range for the LiDAR 260. 50 centimeters determined for the estimation accuracy of the sixth self-localization estimation task is set to be stored in the ROM 120, the RAM 130, or the storage device SD as the radius of the estimation error range for the surrounding camera 270.

Because the variable N is set to 1 in step S225, the CPU 110 serves as, for example, the output self-localization determiner 50 to determine whether the self-position (N) of the vehicle V1 estimated based on the measurement results of the Nth (first) sensor, i.e., the surrounding near-range camera 220 with the first estimation accuracy among the sensors 220 to 270, is within the estimation error range of the (N+1)th sensor, i.e., the LiDAR 260 with the second estimation accuracy among the sensors 220 to 270, in step S230. The estimation error range of the LiDAR 260 is defined as the circular range around the self-position estimated based on the measurement results of the LiDAR 260; the circular range has the radius of 20 centimeters. That is, the output self-localization determiner 50 determines whether the self-position (N) of the vehicle V1 estimated based on the measurement results of the surrounding near-range camera 220 is within the estimation error range of the LiDAR 260 in step S230.

In response to determination that the self-position (N) of the vehicle V1 estimated based on the measurement results of the Nth sensor with the Nth estimation accuracy is within the estimation error range of the (N+1)th sensor with the (N+1)th estimation accuracy (YES in step S230), the CPU 110 serves as, for example, the output self-localization determiner 50 to determine the self-position (N) of the vehicle V1 estimated based on the measurement results of the Nth sensor as the output self-localization position of the vehicle V1 in step S235.

Accordingly, if the self-position of the vehicle V1 estimated based on the measurement results of the surrounding near-range camera 220 is within the circular range, which has the radius of 20 centimeters, around the self-position estimated based on the measurement results of the LiDAR 260, the output self-localization determiner 50 determines the self-position (N) of the vehicle V1 estimated based on the measurement results of the surrounding near-range camera 220 as the output self-localization position of the vehicle V1.

Specifically, if the self-position (N) of the vehicle V1 estimated based on the measurement results of the Nth sensor with the Nth estimation accuracy is within the estimation error range of the (N+1)th sensor with the (N+1)th estimation accuracy, the self-position (N) of the vehicle V1 estimated based on the measurement results of the Nth sensor is likely to represent a correct position of the vehicle V1. The output self-localization determiner 50 of the second embodiment is therefore configured to determine the self-position (N) of the vehicle V1 estimated based on the measurement results of the Nth sensor as the output self-localization position of the vehicle V1.

Otherwise, in response to determination that the self-position (N) of the vehicle V1 estimated based on the measurement results of the Nth sensor with the Nth estimation accuracy is not within the estimation error range of the (N+1)th sensor with the (N+1)th estimation accuracy (NO in step S230), the CPU 110 serves as, for example, the output self-localization determiner 50 to determine whether the determination in step S230 has been completed for all the self-positions estimated based on the measurement results of all the sensors 220 to 270 in step S240.

In response to determination that the determination in step S230 has not been completed for all the self-positions estimated based on the measurement results of all the sensors 220 to 270 (NO in step S240), the CPU 110 serves as, for example, the output self-localization determiner 50 to increment the variable N by 1 in step S250, and thereafter executes the determination in step S230 again.

Accordingly, if execution of the determination in step S230 is the second time, the CPU 110 serves as, for example, the output self-localization determiner 50 to determine whether the self-position (N) of the vehicle V1 estimated based on the measurement results of the LiDAR 260 with the second estimation accuracy is within the estimation error range of the sonar 250 with the third estimation accuracy in step S230.

The estimation error range of the sonar 250 is defined as the circular range around the self-position estimated based on the measurement results of the sonar 250; the circular range has the radius of 30 centimeters.

Otherwise, in response to determination that the determination in step S230 has been completed for all the self-positions estimated based on the measurement results of all the sensors 220 to 270 (YES in step S240), the current execution cycle of the self-localization position determining routine proceeds to step S245.

In step S245, the CPU 110 serves as, for example, the output self-localization determiner 50 not to determine the output self-localization position of the vehicle V1. After completion of the operation in step S235 or S245, i.e., the subroutine in step S125, the current execution cycle of the self-localization position determining routine proceeds to step S130 set forth above.

As clearly seen by the descriptions in steps S205 to S250, upon determination that a predetermined condition that the self-position (N=1) of the vehicle V1 estimated based on the measurement results of the Nth (first) sensor is within the estimation error range of the (N+1)th sensor with the second estimation accuracy is satisfied, the self-localization estimation apparatus 100 of the second embodiment determines the self-position (N=1) of the vehicle V1 estimated based on the measurement results of the Nth (first) sensor as the output self-localization position of the vehicle V1.

The predetermined condition that the self-position (N=1) of the vehicle V1 is within the estimation error range of the (N+1)th sensor, i.e., the second sensor with the second estimation accuracy, corresponds to, for example, a predetermined reliability condition for the self-position estimated based on the measurement results of one of the sensors 220 to 270, which has the highest estimation accuracy.

The self-localization estimation apparatus 100 of the second embodiment achieves the same advantageous benefits as achieved by the self-localization estimation apparatus 100 of the first embodiment.

Additionally, upon determination that the predetermined reliability condition for the self-position estimated based on the measurement results of one of the sensors 220 to 270, which has the highest estimation accuracy is satisfied, the self-localization estimation apparatus 100 of the second embodiment determines, as the output self-localization position of the vehicle V1, the self-position estimated based on the measurement results of one of the sensors 220 to 270, which has the highest estimation accuracy.

This therefore makes it possible to further limit a deterioration in accuracy of self-positions of the vehicle V1 estimated based on the surrounding environments around the vehicle V1 measured by the sensors 220 to 270. The predetermined reliability condition for the self-position estimated based on the measurement results of one of the sensors 220 to 270, which has the highest estimation accuracy, may include, for example, the predetermined condition that the self-position (N=1) of the vehicle V1 estimated based on the measurement results of the Nth (first) sensor, i.e., the surrounding near-range camera 220, with the first estimation accuracy is within the estimation error range of the (N+1)th (second) sensor, i.e., the LiDAR 260, with the second estimation accuracy.

Let us assume that the self-position estimated based on the measurement results of the surrounding near-range camera 220 with the highest estimation accuracy has a certain amount of error so as to be outside the estimation error range of the LiDAR 260 with the second highest estimation accuracy caused by, for example, a failure of the surrounding near-range camera 220 or the image captured by the surrounding near-range camera 220 being unclear due to snowfall.

In this assumption, the above configuration of the self-localization estimation apparatus 100 of the second embodiment makes it possible not to determine the self-position of the vehicle V1 estimated based on the measurement results of the surrounding near-range camera 220.

Additionally, even if the reliability condition for the self-position estimated based on the measurement results of one of the sensors 220 to 270, which has the highest estimation accuracy, is not satisfied, the above configuration of the self-localization estimation apparatus 100 of the second embodiment makes it possible to determine, as the output self-localization position of the vehicle V1, a selected one of the self-positions of the vehicle V1; the selected one of the self-positions of the vehicle V1 has one of the second and subsequent highest estimation accuracies. This prevents the occurrence of a situation where the self-localization estimation apparatus 100 of the second embodiment cannot determine the output self-localization position of the vehicle V1.

### Third Embodiment

A self-localization estimation apparatus 100a of the third embodiment differs from the self-localization estimation apparatus 100 of the first embodiment in that the CPU 110 of the self-localization estimation apparatus 100a serves as an environmental information acquiring unit 60. Reference characters used for the other components of the self-localization estimation apparatus 100 of the first embodiment are assigned to the same components of the self-localization estimation apparatus 100a of the third embodiment, and therefore the detailed descriptions for the same components of the self-localization estimation apparatus 100a of the third embodiment are omitted.

The environmental information acquiring unit 60 is configured to acquire information related to the surrounding environments around the vehicle V1, which will be referred to as surrounding-environment information, and transmit, to each of the first to sixth estimation accuracy determiners 21 to 26, the acquired surrounding-environment information.

The surrounding-environment information includes, for example, weather information on the weather of the place in which the vehicle V1 is traveling and time-zone information on the time zone in which the vehicle V1 is traveling.

The weather information includes, for example, weather conditions around the vehicle V1, which are likely to impact on the measurement results of at least one of the sensors 220 to 270. The weather conditions around the vehicle V1 include, for example, a rainfall condition, a snowfall condition, or a snowy road condition. For example, if it is raining or snowing around the vehicle V1, the rainfall condition or the snowfall condition may impact on the measurement results of camera sensors included in the sensors 220 to 270, such as the surrounding near-range camera 220, the front view camera 230, or the surrounding camera 270. The weather information may therefore cause the estimation accuracy of at least one of the sensors 220 to 270 to decrease.

The environmental information acquiring unit 60 can be configured to acquire the weather information, such as a rainfall condition, a snowfall condition, or a snowy road condition, from measurement 30 results of a rainfall sensor RS installed in the vehicle V1 or estimate the weather information, such as a rainfall condition, a snowfall condition, or a snowy road condition, from the operating conditions of wipers of the vehicle V1. The environmental information acquiring unit 60 can be configured to communicate with a weather server included in external servers ES to accordingly acquire the weather information.

The time-zone information on the time zone in which the vehicle V1 is traveling may impact on the measurement results of at least one of the sensors 220 to 270. For example, the time-zone information includes a nighttime zone or a time zone in which strong afternoon sun is shining on the road surfaces around the vehicle V1.

The environmental information acquiring unit 60 can be configured to acquire the time-zone information, such as a nighttime zone or a time zone in which strong afternoon sun is shining on the road surfaces around the vehicle V1, from measurement results of an illumination sensor IS installed in the vehicle V1 or estimate the time-zone information based on time information supplied from (i) a watch W installed in the vehicle V1 or a time server included in the external servers ES.

A self-localization position determining routine according to the third embodiment differs from the self-localization position determining routine according to the first embodiment in the following points:

Specifically, the CPU 110 additionally executes an operation in step S107, and executes an operation in step S115a in place of the operation in step S105, and therefore the other operations of the self-localization position determining routine of the third embodiment are identical to the respective corresponding operations of the self-localization position determining routine of the third embodiment.

For this reason, step numbers used for the corresponding operations of the self-localization position determining routine of the first embodiment are respectively assigned to the same operations of the self- localization position determining routine of the third embodiment, and therefore the detailed descriptions for the same operations of the self-localization position determining routine of the third embodiment are omitted.

After completion of the operation in step S105, the CPU 110 serves as, for example, the environmental information acquiring unit 60 to acquire the surrounding-environment information as described above, and transmit, to each of the first to sixth estimation accuracy determiners 21 to 26, the acquired surrounding-environment information in step S107.

After completion of the operation in step S107, the CPU 110 serves as, for example, each of the first to sixth position estimators 11 to 16 to perform the corresponding one of the first to sixth self-localization estimation tasks to accordingly estimate the corresponding one of the self-positions of the vehicle V1 in the reference coordinate system in step S110.

After completion of the operation in step S107, the CPU 110 serves as, for example, each of the first to sixth estimation accuracy determiners 21 to 26 to adjust, based on the surrounding-environment information, a value of the estimation accuracy of the corresponding one of the self-positions of the vehicle V1 estimated by the corresponding one of the first to sixth self-localization estimation tasks to accordingly determine the adjusted value of the estimation accuracy of the corresponding one of the self-positions of the vehicle V1 estimated by the corresponding one of the first to sixth self-localization estimation tasks in step S115a.

For example, the ROM 120 stores beforehand an estimation accuracy table T described hereinafter, and each of the first to sixth estimation accuracy determiners 21 to 26 is configured to refer to the estimation accuracy table T to accordingly adjust a value of the estimation accuracy of each of the self-positions of the vehicle V1 estimated by the corresponding one of the first to sixth self-localization estimation tasks.

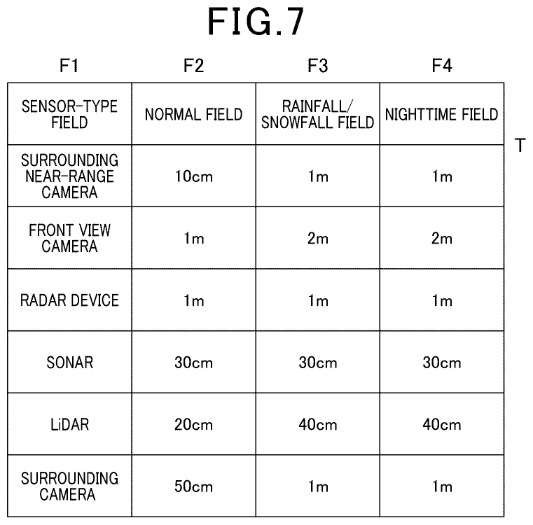

The estimation accuracy table T is comprised of, as illustrated in FIG. 7, a sensor-type field F1, a normal field F2, a rainfall/snowfall field F3, and a nighttime field F4.

The sensor-type field F1 represents the type of the sensors 220 to 270 and is comprised of first to sixth field values: the first field value represents the surrounding near-range camera 220, the second field value represents the front view camera 230, the third field value represents the radar device 240, the fourth field value represents the sonar 250, the fifth field value represents the LiDAR 260, and the sixth field value represents the surrounding camera 270.

The normal field F2 represents a normal value of the estimation accuracy of each of the self-positions of the vehicle V1 estimated by the corresponding one of the first to sixth self-localization estimation tasks in normal situations. Normal situations represent all situations except for a rainfall situation, a snowfall situation, and a nighttime situation, i.e., the situation in the nighttime zone. Specifically, the normal field F2 is comprised of first to sixth field values: the first field value is 10 centimeters as the value of the estimation accuracy of the first self-localization estimation task in normal situations, the second field value is 1 meter as the value of the estimation accuracy of the second self-localization estimation task in normal situations, the third field value is 1 meter as the value of the estimation accuracy of the third self-localization estimation task in normal situations, the fourth field value is 30 centimeters as the value of the estimation accuracy of the fourth self-localization estimation task in normal situations, the fifth field value is 20 centimeters as the value of the estimation accuracy of the fifth self-localization estimation task in normal situations, and the sixth field value is 50 centimeters as the value of the estimation accuracy of the sixth self- localization estimation task in normal situations.

The rainfall/snowfall field F3 represents a value of the estimation accuracy of each of the self-positions of the vehicle V1 estimated by the corresponding one of the first to sixth self-localization estimation tasks in the rainfall situation or the snowfall situation. Specifically, the rainfall/snowfall field F3 is comprised of first to sixth field values: the first field value is 1 meter as the value of the estimation accuracy of the first self-localization estimation task in the rainfall situation or the snowfall situation, the second field value is 2 meters as the value of the estimation accuracy of the second self-localization estimation task in the rainfall situation or the snowfall situation, the third field value is 1 meter as the value of the estimation accuracy of the third self-localization estimation task in the rainfall situation or the snowfall situation, the fourth field value is 30 centimeters as the value of the estimation accuracy of the fourth self-localization estimation task in the rainfall situation or the snowfall situation, the fifth field value is 40 centimeters as the value of the estimation accuracy of the fifth self-localization estimation task in the rainfall situation or the snowfall situation, and the sixth field value is 1 meter as the value of the estimation accuracy of the sixth self-localization estimation task in the rainfall situation or the snowfall situation.

The nighttime field F4 represents a value of the estimation accuracy of each of the self-positions of the vehicle V1 estimated by the corresponding one of the first to sixth self-localization estimation tasks in the nighttime situation. Specifically, the nighttime field F4 is comprised of first to sixth field values: the first field value is 1 meter as the value of the estimation accuracy of the first self-localization estimation task in the nighttime situation, the second field value is 2 meters as the value of the estimation accuracy of the second self-localization estimation task in the nighttime situation, the third field value is 1 meter as the value of the estimation accuracy of the third self-localization estimation task in the nighttime situation, the fourth field value is 30 centimeters as the value of the estimation accuracy of the fourth self-localization estimation task in the nighttime situation, the fifth field value is 40 centimeters as the value of the estimation accuracy of the fifth self-localization estimation task in the nighttime situation, and the sixth field value is 1 meter as the value of the estimation accuracy of the sixth self-localization estimation task in the nighttime situation.

The value of the estimation accuracy of each of the first, second, fifth, and sixth self-localization estimation tasks based on the measurement results of the sensors 220, 230, 260, and 270 in the rainfall/snowfall situations is smaller than that in normal situations. Similarly, the value of the estimation accuracy of each of the first, second, fifth, and sixth self-localization estimation tasks based on the measurement results of the sensors 220, 230, 260, and 270 in the nighttime situation is smaller than that in normal situations.

In contrast, the value of the estimation accuracy of each of the third and fourth self-localization estimation tasks based on the measurement results of the sensors 240 and 250 is constant for each of the (i) normal situations, (ii)the rainfall/snowfall situation, and (iii)the nighttime situation. The values of the estimation accuracy of each of the first to sixth self-localization estimation tasks in each of the (i) normal situations, (ii)the rainfall/snowfall situation, and (iii)the nighttime situation were previously identified using, for example, experiments or simulations.

As clearly shown in the estimation accuracy table T, one of the sensors 220 to 270, which has the highest value of the estimation accuracy in normal situation is the surrounding near-range camera 220. In contrast, one of the sensors 220 to 270, which has the highest value of the estimation accuracy in the rainfall/snowfall situation or the nighttime situation is the sonar 250.

In step S115a, if the surrounding environments around the vehicle V1 specified by the surrounding-environment information represent the snowfall situation, the first estimation accuracy determiner 21 determines 1 meter as the value of the estimation accuracy of the first self-localization estimation task based on the measurement results of the surrounding near-range camera 220. Similarly, in step S115a, if the surrounding environments around the vehicle V1 specified by the surrounding-environment information represent the nighttime situation, the fourth estimation accuracy determiner 24 determines 30 centimeters as the value of the estimation accuracy of the fourth self-localization estimation task based on the measurement results of the sonar 250, which is identical to that when the surrounding-environment information represents normal situation.

After completion of the operation in step S115a, the CPU 110 serves as, for example, at least one of the first to sixth position estimators 11 to 16 to transmit, to the output self-localization determiner 50, (i)the corresponding at least one of the self-positions of the vehicle V1 estimated thereby and (ii) the determined value of the estimation accuracy of the corresponding at least one of the first to sixth position estimators 11 to 16 in step S120. After completion of the operation in step S120, the CPU 110 serves as, for example, the output self-localization determiner 50 to perform the determination subroutine that determines, based on the at least one of the self-positions of the vehicle V1 and the determined value of the estimation accuracy of the at least one of the first to sixth position estimators 11 to 16, the output self-localization position of the vehicle V1 in step S125.

Accordingly, this configuration results in, in normal situations, the self-position of the vehicle V1 estimated by the first self-localization estimation task based on the measurement results of the surrounding near-range camera 220 being determined as the output self-localization position of the vehicle V1. Additionally, this configuration results in, in the rainfall situation, snowfall situation, or the nighttime situation, the self-position of the vehicle V1 estimated by the fourth self-localization estimation task based on the measurement results of the sonar 250 being determined as the output self-localization position of the vehicle V1.

The self-localization estimation apparatus 100a of the third embodiment achieves the same advantageous benefits as achieved by the self-localization estimation apparatus 100 of the first embodiment.

In particular, each of the first to sixth estimation accuracy determiners 21 to 26 of the third embodiment is configured to adjust, based on the surrounding environments around the vehicle V1 specified by the surrounding-environment information, a value of the estimation accuracy of each of the first to sixth self-localization estimation tasks.

Additionally, the output self-localization determiner 50 is configured to determine, based on the adjusted value of the estimation accuracy of each of the first to sixth self-localization estimation tasks, one of the self-positions of the vehicle V1 estimated based on the measurement results of the sensors 220 to 270. This configuration of the self-localization estimation apparatus 100a results in the output self-localization position of the vehicle V1 being more precisely determined to be suitable for the surrounding environments around the vehicle V1.

The surrounding-environment information includes the weather information on the weather of the place in which the vehicle V1 is traveling and the time-zone information on the time zone in which the vehicle V1 is traveling. This configuration of the self-localization estimation apparatus 100a results in the output self-localization position of the vehicle V1 being more precisely determined to be suitable for the weather of the place in which the vehicle V1 is traveling and/or the time zone in which the vehicle V1 is traveling.

### Modifications

The self-localization estimation apparatus 100 of the second embodiment is configured to iterate the determination of whether the self-position (N) of the vehicle V1 estimated based on the measurement results of the Nth sensor is within the estimation error range of the (N+1)th sensor in step S230 until the determination in step S230 has been completed for all the self-positions estimated based on the measurement results of all the sensors 220 to 270. The present disclosure is however not limited to the above configuration.

Specifically, upon determination that the self-position of the vehicle V1 estimated based on the measurement results of the third sensor with the third estimation accuracy is not within the estimation error range of the fourth sensor with the fourth estimation accuracy (NO in step S230), the self-localization estimation apparatus 100 can be configured not to determine the output self-localization position of the vehicle V1 in step S245.

Each of the first to sixth matching tasks according to each embodiment is configured to refer to, based on the GNSS estimated position of the vehicle V1, the limited range of the map information I; the positional information items included in the limited range of the map information I enclose the GNSS estimated position of the vehicle V1. The present disclosure is however not limited to the above configuration.

Specifically, each of the first to sixth matching tasks according to the present disclosure can be configured not to limit the range of the map information I to be referred to. This modification enables the GNSS devices 210 and the GNSS position estimator 40 to be omitted.

The surrounding-environment information according to the third embodiment includes both the weather information on the weather of the place in which the vehicle V1 is traveling and the time-zone information on the time zone in which the vehicle V1 is traveling, but the present disclosure is not limited thereto. Specifically, one of the weather information and the time-zone information can be omitted. In place of or in addition to at least one of the weather information and the time-zone information, the surrounding-environment information can include another type of information related to the surrounding environments around the vehicle V1.

Each of the first to third embodiments describes the self-localization estimation apparatus 100, 100a mounted to the vehicle V1, but the present disclosure is not limited thereto. Specifically, the present disclosure can include cases where the self-localization estimation apparatus 100, 100a is mounted to any mobile object, such as an aircraft or a ship.

The self-localization estimation apparatuses 100, 100a and their estimation methods according to the present disclosure can be implemented by a dedicated computer including a memory and a processor programmed to perform one or more functions embodied by one or more computer programs.

The self-localization estimation apparatuses 100, 100a and their estimation methods according to the present disclosure can also be implemented by a dedicated computer including a processor comprised of one or more dedicated hardware logic circuits.

The self-localization estimation apparatuses 100, 100a and their estimation methods according to the present disclosure can further be implemented by a processor system comprised of a memory, a processor programmed to perform one or more functions embodied by one or more computer programs, and one or more hardware logic circuits.

The one or more programs can be stored in a computer-readable non-transitory storage medium as instructions to be carried out by a computer or a processor.

The present disclosure is not limited to the above embodiments, and can be implemented by various configurations within the scope of the present disclosure. For example, technical features included in the embodiments, which correspond to technical features included in exemplary measures described in the SUMMARY of the present disclosure, can be freely combined with each other or can be freely replaced with another feature in order to solve a part or all of the above issue and/or achieve a part or all of the above advantageous benefits. One or more of the technical features included in the above exemplary embodiment, which are not described as essential elements in the specification, can be omitted as necessity arises.

The following describes first to twelfth technological concepts.

### [First Technological Concept]

The self-localization estimation apparatus (100, 100a) of the first technological concept is to be used for a mobile object (V1) equipped with a plurality of sensors (220 to 270). Each of the sensors is configured to measure, as a measurement result, surrounding environments around the mobile object. The first characteristic self-localization estimation apparatus includes a self-position estimating unit (11 to 16) configured to perform a plurality of self-position estimation tasks corresponding to the respective sensors with respective estimation accuracies, each of the estimation accuracies depending on a measurement characteristic of the corresponding one of the sensors.

The self-localization estimation apparatus of the first technological concept includes an output self-position determiner (50) configured to determine, based on analysis of estimation results and the estimation accuracies of the respective self-position estimation tasks, a self-position of the mobile object estimated by a selected one of the self-position estimation tasks as an output self-localization position of the mobile object.

### [Second Technological Concept]

In the self-localization estimation apparatus of the second technological concept, which depends on the first technological concept, the output self-position determiner is configured to determine whether a highest estimation accuracy among the estimation accuracies of the respective self-position estimation tasks satisfies a reliability condition previously determined for the highest estimation accuracy. The output self-position determiner is configured to determine, upon determination that the highest estimation accuracy satisfies the reliability condition, a first self-position of the mobile object estimated by the self-position estimation task that has the highest estimation accuracy as the output self-localization position of the mobile object.

### [Third Technological Concept]

In the self-localization estimation apparatus of the third technological concept, which depends on the second technological concept, the estimation accuracies of the respective self-position estimation tasks additionally include a second highest estimation accuracy thereamong. The predetermined reliability condition includes a condition where the first self-position of the mobile object estimated by the self-position estimation task that has the highest estimation accuracy is within an estimation error range of a second self-position of the mobile object estimated by the self-position estimation task that has the second highest estimation accuracy.

### [Fourth Technological Concept]

In the self-localization estimation apparatus of the fourth technological concept, which depends on the third technological concept, the estimation accuracies of the respective self-position estimation tasks additionally include a third and subsequent highest estimation accuracies thereamong. The output self-position determiner is configured to determine, upon determination that the highest estimation accuracy does not satisfy the reliability condition, the second self-position or a further one self-position of the mobile object as the output self-localization position of the mobile object, the further one self-position of the mobile object being estimated by the self-position estimation task that has any one of the third and subsequent highest estimation accuracies.

### [Fifth Technological Concept]

The self-localization estimation apparatus of the fifth technological concept, which depends on any one of the first to fourth technological concepts, further includes an environmental information acquiring unit (60) configured to acquire, as surrounding-environment information, information related to surrounding environments around the mobile object. The self-position estimating unit includes an estimation accuracy determiner (21 to 26) configured to determine, for each of the self-position estimation tasks, the corresponding one of the estimation accuracies. The estimation accuracy of each of the self-position estimation tasks is previously determined based on at least one of the measurement result and previous measurement results of the corresponding one of the sensors. The estimation accuracy determiner is configured to adjust, for each of the self-position estimation tasks, a value of the corresponding one of the estimation accuracies based on the surrounding-environment information. The output self-position determiner is configured to determine, based on the analysis of the estimation results and the adjusted values of the estimation accuracies of the respective self-position estimation tasks, the self-position of the mobile object estimated by the selected one of the self-position estimation tasks as the output self-localization position of the mobile object.

### [Sixth Technological Concept]

In the self-localization estimation apparatus of the sixth technological concept, which depends on the fifth technological concept, the surrounding-environment information includes at least one of:
weather information on a weather of a place in which the mobile object is traveling; and
time-zone information on a time zone in which the mobile object is traveling.

### [Seventh Technological Concept]

In the self-localization estimation apparatus of the seventh technological concept, which depends on the first technological concept, the output self-position determiner is configured to determine whether each of the self-position estimation tasks is successful in a corresponding self-position of the mobile object in accordance with the measurement results of the respective self-position estimation tasks.

Additionally, the output self-position determiner is configured to determine, upon selected self-position estimation tasks in the self-position estimation tasks being determined to be successful in the corresponding self-positions of the mobile object, one of the self-positions of the mobile object estimated by the respective selected successful self-position estimation tasks.

### [Eighth Technological Concept]

In the self-localization estimation apparatus of the eighth technological concept, which depends on the first technological concept, a relationship between various features existing around the mobile object and respectively corresponding positional information items is stored in the mobile object or the self-localization estimation apparatus as map information (I). Each of the self-position estimation tasks is configured to refer to the map information using specific features included in the measurement result of the corresponding one of the sensors to accordingly perform estimation of a corresponding self-position of the mobile object.

### [Ninth Technological Concept]

The self-localization estimation apparatus of the ninth technological concept, which depends on the eighth technological concept, further includes a satellite-system position estimator configured to receive positioning signals from global positioning satellites to accordingly estimate a current position of the mobile object. Each of the self-position estimation tasks is configured to perform a first estimation of referring to a first limited range of the map information using first specific features included in a first measurement result as the measurement result of the corresponding one of the sensors. Each of the self-position estimation tasks is configured to estimate, based on the first estimation, the corresponding one of the self-positions of the mobile object as a first self-position of the mobile object, so that the output self-position determiner determines a first final self-localization position of the mobile object as the output self-localization position of the mobile object, the first limited range of the map information for each of the self-position estimation tasks enclosing the current position of the mobile object estimated by the satellite-system position estimator.

### [Tenth Technological Concept]

In the self-localization estimation apparatus of the tenth technological concept, which depends on the ninth technological concept, each of the self-position estimation tasks is configured to perform a second estimation of referring to a second limited range of the map information using second specific features included in, as the measurement result, a second measurement result as the measurement result of the corresponding one of the sensors to accordingly estimate, as a second self-position of the mobile object, the corresponding one of the self-positions of the mobile object, the second limited range of the map information for each of the self-position estimation tasks enclosing the first final self-localization position of the mobile object.

### [Eleventh Technological Concept]

In the self-localization estimation apparatus of the eleventh technological concept, which depends on the first technological concept, the sensors include at least one of (i) at least one camera configured to capture, as the measurement result of the at least one camera, one or more images of a predetermined region located to surround the mobile object, and (ii) at least one probe sensor.

The at least one probe sensor is configured to emit probe waves, receive reflections of the emitted probe waves from at least one object located around the mobile object, and analyze the received reflections to accordingly calculate information on the at least one object as the measurement result of the corresponding at least one probe sensor.

[Twelfth technological concept]

A program product of the twelfth technological concept for self-localization of a mobile object (V1) equipped with a plurality of sensors (220 to 270), each of which is configured to measure, as a measurement result, surrounding environments around the mobile object. The program product includes a non-transitory storage medium (120, 130) that stores program instructions, and a processor (110) for executing the program instructions stored in the non-transitory storage medium. The program instructions cause the processor to:
perform a plurality of self-position estimation tasks corresponding to the respective sensors with respective estimation accuracies, each of the estimation accuracies depending on a measurement characteristic of the corresponding one of the sensors; and
determine, based on analysis of estimation results and the estimation accuracies of the respective self-position estimation tasks, an output self-localization position of the mobile object estimated by one of the self-position estimation tasks.

1. A self-localization estimation apparatus for a mobile object equipped with a plurality of sensors, each of which is configured to measure, as a measurement result, surrounding environments around the mobile object, the self-localization estimation apparatus comprising:
a self-position estimating unit configured to perform a plurality of self-position estimation tasks corresponding to the respective sensors with respective estimation accuracies, each of the estimation accuracies depending on a measurement characteristic of the corresponding one of the sensors; and
an output self-position determiner configured to determine, based on analysis of estimation results and the estimation accuracies of the respective self-position estimation tasks, a self-position of the mobile object estimated by a selected one of the self-position estimation tasks as an output self-localization position of the mobile object.

2. The self-localization estimation apparatus according to claim 1, wherein:
the output self-position determiner is configured to:
determine whether a highest estimation accuracy among the estimation accuracies of the respective self-position estimation tasks satisfies a reliability condition previously determined for the highest estimation accuracy; and
determine, upon determination that the highest estimation accuracy satisfies the reliability condition, a first self-position of the mobile object estimated by the self-position estimation task that has the highest estimation accuracy as the output self-localization position of the mobile object.

3. The self-localization estimation apparatus according to claim 2, wherein:
the estimation accuracies of the respective self-position estimation tasks additionally include a second highest estimation accuracy thereamong; and
the predetermined reliability condition includes a condition where the first self-position of the mobile object estimated by the self-position estimation task that has the highest estimation accuracy is within an estimation error range of a second self-position of the mobile object estimated by the self-position estimation task that has the second highest estimation accuracy.

4. The self-localization estimation apparatus according to claim 3, wherein:
the estimation accuracies of the respective self-position estimation tasks additionally include a third and subsequent highest estimation accuracies thereamong; and
the output self-position determiner is configured to determine, upon determination that the highest estimation accuracy does not satisfy the reliability condition, the second self-position or a further one self-position of the mobile object as the output self-localization position of the mobile object, the further one self-position of the mobile object being estimated by the self-position estimation task that has any one of the third and subsequent highest estimation accuracies.

5. The self-localization estimation apparatus according to claim 1, further comprising:
an environmental information acquiring unit (60) configured to acquire, as surrounding-environment information, information related to surrounding environments around the mobile object,
wherein:
the self-position estimating unit comprises an estimation accuracy determiner configured to determine, for each of the self-position estimation tasks, the corresponding one of the estimation accuracies, the estimation accuracy of each of the self-position estimation tasks being previously determined based on at least one of the measurement result and previous measurement results of the corresponding one of the sensors;
the estimation accuracy determiner is configured to adjust, for each of the self-position estimation tasks, a value of the corresponding one of the estimation accuracies based on the surrounding-environment information; and
the output self-position determiner is configured to determine, based on the analysis of the estimation results and the adjusted values of the estimation accuracies of the respective self-position estimation tasks, the self-position of the mobile object estimated by the selected one of the self-position estimation tasks as the output self-localization position of the mobile object.

6. The self-localization estimation apparatus according to claim 5, wherein:
the surrounding-environment information includes at least one of:
weather information on a weather of a place in which the mobile object is traveling; and
time-zone information on a time zone in which the mobile object is traveling.

7. The self-localization estimation apparatus according to claim 1, wherein:
the output self-position determiner is configured to:
determine whether each of the self-position estimation tasks is successful in a corresponding self-position of the mobile object in accordance with the measurement results of the respective self-position estimation tasks; and
determine, upon selected self-position estimation tasks in the self-position estimation tasks being determined to be successful in the corresponding self-positions of the mobile object, one of the self-positions of the mobile object estimated by the respective selected successful self-position estimation tasks.

8. The self-localization estimation apparatus according to claim 1, wherein:
a relationship between various features existing around the mobile object and respectively corresponding positional information items is stored in the mobile object or the self-localization estimation apparatus as map information; and
each of the self-position estimation tasks is configured to refer to the map information using specific features included in the measurement result of the corresponding one of the sensors to accordingly perform estimation of a corresponding self-position of the mobile object.

9. The self-localization estimation apparatus according to claim 8, further comprising:
a satellite-system position estimator configured to receive positioning signals from global positioning satellites to accordingly estimate a current position of the mobile object,
wherein:
each of the self-position estimation tasks is configured to:
perform a first estimation of referring to a first limited range of the map information using first specific features included in a first measurement result as the measurement result of the corresponding one of the sensors; and
estimate, based on the first estimation, the corresponding one of the self-positions of the mobile object as a first self-position of the mobile object, so that the output self-position determiner determines a first final self-localization position of the mobile object as the output self-localization position of the mobile object, the first limited range of the map information for each of the self-position estimation tasks enclosing the current position of the mobile object estimated by the satellite-system position estimator.

10. The self-localization estimation apparatus according to claim 9, wherein:
each of the self-position estimation tasks is configured to:
perform a second estimation of referring to a second limited range of the map information using second specific features included in, as the measurement result, a second measurement result as the measurement result of the corresponding one of the sensors to accordingly estimate, as a second self-position of the mobile object, the corresponding one of the self-positions of the mobile object, the second limited range of the map information for each of the self-position estimation tasks enclosing the first final self-localization position of the mobile object.

11. The self-localization estimation apparatus according to claim 1, wherein:
the sensors include at least one of:
at least one camera configured to capture, as the measurement result of the at least one camera, one or more images of a predetermined region located to surround the mobile object; and
at least one probe sensor configured to:
emit probe waves;
receive reflections of the emitted probe waves from at least one object located around the mobile object; and
analyze the received reflections to accordingly calculate information on the at least one object as the measurement result of the corresponding at least one probe sensor.

12. A program product for self-localization of a mobile object equipped with a plurality of sensors, each of which is configured to measure, as a measurement result, surrounding environments around the mobile object, the program product comprising:
a non-transitory storage medium; and
program instructions stored in the non-transitory storage medium, the program instructions causing a processor to:
perform a plurality of self-position estimation tasks corresponding to the respective sensors with respective estimation accuracies, each of the estimation accuracies depending on a measurement characteristic of the corresponding one of the sensors; and
determine, based on analysis of estimation results and the estimation accuracies of the respective self-position estimation tasks, an output self-localization position of the mobile object estimated by one of the self-position estimation tasks.
